(19) United States
(12) Patent Application Publication
(10) Pub. No.: US 2014/0282625 A1
(43) Pub. Date: Sep. 18, 2014

(54) ASYNCHRONOUS PROGRAMMING MODEL FOR CONCURRENT WORKFLOW SCENARIOS

(71) Applicants: Pablo Chico de Guzman Huerta, Murica (ES); Alberto Arias Maestro, Mountain View, CA (US); Amadeo Casas Cuadrado, Mountain View, CA (US)

(72) Inventors: Pablo Chico de Guzman Huerta, Murica (ES); Alberto Arias Maestro, Mountain View, CA (US); Amadeo Casas Cuadrado, Mountain View, CA (US)

(21) Appl. No.: 14/209,723

(22) Filed: Mar. 13, 2014

Related U.S. Application Data
(60) Provisional application No. 61/780,223, filed on Mar. 13, 2013.

(51) Int. Cl. G06F 9/54

(52) U.S. Cl. CPC G06F 9/54
USPC 719/320

(57) ABSTRACT

Asynchronous functions in a programming workflow are executed by first storing a context structure comprising workflow-specific global variables and a global-context pointer variable that is a pointer to the context structure. When an asynchronous function is executed, the global-context pointer variable is stored in a local variable and, when the function completes, the global-context pointer variable is restored with the local variable.

### CROSS-REFERENCE TO RELATED APPLICATIONS

This application claims priority to and the benefit of U.S. Provisional Patent Application Ser. No. 61/780,223, filed on Mar. 13, 2013, which is hereby incorporated herein by reference in its entirety.

### TECHNICAL FIELD

Embodiments of the present invention relate generally to asynchronous programming and, in particular, to the concurrent execution of multiple workflows having asynchronous function calls.

### BACKGROUND

Asynchronous programming models and/or techniques (based on event-handling patterns) have been adopted for certain applications, such as network-server implementations, due in part to its high performance, scalability, and simplified synchronization protocols. In asynchronous programming, the main execution thread maintains a “waiting state” that is responsible for selecting/polling a set of events. Each of these events is associated with a function, referred to herein as a callback function, which is executed asynchronously when the event occurs, is received, or is otherwise triggered. The main execution thread may be responsible for executing the callback functions before returning to the waiting state again.

Event-handling patterns may decouple application demultiplexing and dispatching mechanisms from application-specific hook-method functionality, thereby improving modularity, portability, reusability, and/or configurability of event-driven applications. These patterns may also serialize the invocation of event handlers at the level of event demultiplexing and dispatching, often eliminating the need for more complicated synchronization or locking within an application process. As a single-threaded application process, however, callbacks are not preempted while they are executing, they should not perform blocking I/O because that might block the entire process and impede the responsiveness for other requests, and they should not be computationally expensive in order to reduce response latency.

### SUMMARY

In general, various aspects of the systems and methods described herein execute asynchronous functions in a programming workflow by first storing a context structure comprising workflow-specific global variables and a global-context pointer variable that is a pointer to the context structure. When an asynchronous function is executed, the global-context pointer variable is stored in a local variable and, when the function completes, the global-context pointer variable is restored with the local variable. In one embodiment, promises are stored in the context structure, and the workflow is cancelled by cancelling the promises. These asynchronous functions may be designated sequential functions; in other embodiments, a group parallel functions wait to return a final promise until all of the parallel functions have completed.

In one aspect, a method for executing asynchronous functions in a programming workflow includes storing, in a computer memory, a context structure comprising workflow-specific global variables; storing, in the computer memory, a global-context pointer variable comprising a pointer to the context structure; storing the global-context pointer variable in a local variable of an asynchronous function; executing with a computer processor, from a waiting state of the programming workflow, the asynchronous function; and restoring the global-context pointer variable with the local variable.

A promise for the asynchronous function may be stored in the context structure. The context structure may store promises for a plurality of asynchronous functions. The programming workflow may be cancelled by cancelling all of the promises in the context structure. A promise may be generated for the asynchronous function, wherein the asynchronous function has been marked as sequential. The asynchronous function may be marked as parallel. A promise that is to be triggered may be returned when the asynchronous function and at least one other asynchronous function marked as parallel have completed execution.

In another aspect, a system for executing asynchronous functions in a programming workflow includes a computer processor configured for executing computer instructions for computationally executing the steps of: storing a context structure comprising workflow-specific global variables; storing a global-context pointer variable comprising a pointer to the context structure; storing the global-context pointer variable in a local variable of an asynchronous function; executing with a computer processor, from a waiting state of the programming workflow, the asynchronous function; and restoring the global-context pointer variable with the local variable; and a computer memory for storing the context structure and global-context pointer variable.

The computer process may be further configured for storing a promise for the asynchronous function in the context structure. The context structure may store promises for a plurality of asynchronous functions. The computer process may be further configured for cancelling the programming workflow by cancelling all of the promises in the context structure. The computer process may be further configured for generating a promise for the asynchronous function, wherein the asynchronous function has been marked as sequential. The asynchronous function may be marked as parallel. The computer process may be further configured for returning a promise that is to be triggered when the asynchronous function and at least one other asynchronous function marked as parallel have completed execution.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a flow diagram of an exemplary map-reduce workflow in accordance with embodiments of the present invention; and

FIG. 2 is a block diagram of workflows and associated contexts in accordance with embodiments of the present invention; and

FIG. 3 is a system for asynchronous programming and workflows in accordance with embodiments of the present invention.

### DETAILED DESCRIPTION

Described herein are various embodiments of methods and systems for the concurrent execution of workflows in the context of asynchronous programming models. As the term is used herein, an asynchronous workflow includes a sequence of connected steps that together generate a response to an external request. Each step usually includes the finishing of the performance of an asynchronous call; subsequent steps may execute only after the response to this call is ready if the subsequent steps depend on the results of previous steps.

A workflow execution may, therefore, be split in several callbacks, each associated with the asynchronous call responses, which are discontinuously computed (i.e., computed asynchronously). Callbacks belonging to other workflows may be concurrently computed between or during the execution of the callbacks of the given workflow. In addition, some or all of the asynchronous calls invoked by the given workflow might be executed in parallel (as well as callbacks belonging to other workflows).

An example of this scenario is the workflow associated with a map-reduce operation in a set of databases. The map-reduce workflow may first perform an asynchronous call to obtain a list of running database instances. Then, the workflow may call an asynchronous map operation for each of the database instances in parallel; once all the map operations have returned their results, the workflow may perform the reduce operation.

FIG. 1 illustrates an exemplary execution of a map-reduce workflow 100 using an asynchronous programming model. The execution starts in a waiting state 102 of a main execution thread and checks/waits for map-reduce requests. A map-reduce request 104 received from an external source initiates the execution of the workflow, whose first callback 106 calls an asynchronous function, get_databases( ), to obtain the list of running database instances. The get_databases( ) function is an asynchronous call that immediately or soon after being called (i.e., before its final response is ready) returns to the waiting state, where other events may be concurrently processed. Once the response of the get_databases( ) function is ready, the main thread initiates another callback function 108, which in turn calls, in parallel, a plurality of asynchronous map( ) operations (e.g., one for each database). After all the asynchronous map( ) operations have communicated to the main execution thread that their response is ready, the main thread initiates another callback 110 to perform the reduce( ) operation and returns the response 112 for the original map-reduce request.

To facilitate the programming model of event-handling patterns, asynchronous model implementations usually support a promise pattern, in which promises are associated with asynchronous calls after the call is made but before the execution returns to the waiting state. The promise pattern implementations usually support the serialization of promises to obtain the result of an asynchronous call, in a similar manner to the one of synchronous calls, allowing for more sequential-like implementations. Therefore, the promise remembers the subsequent execution point of the asynchronous call and jumps there when the response of the asynchronous call is received. Promises may be cancelled in order to avoid the computation of their associated callbacks.

In one embodiment of the present invention, a program transformation for functions generates a set of promises. These functions may be marked (by, e.g., a user, compiler, or any other source) as sequential or parallel and therefore expected to execute the generated promises (and therefore, their associated asynchronous calls) in sequence or parallel, respectively. The sequential program transformation may incorporate some or all aspects of the promises serialization described above. In various embodiments, the sequential program transformation addresses two scenarios that appear in asynchronous programming models: (1) workflows usually need workflow-specific global variables, but the implementation of workflow-specific global variables is not trivial because every workflow may execute in the same single thread, and (2) workflows may need to be cancelled, but the implementation of (e.g.) a kill signal is not trivial at least because cancelling a single workflow may cancel the main single thread.

In one embodiment, a specific context is created and associated with each concurrent workflow. FIG. 2 illustrates a block diagram 200 of exemplary workflows and associated contexts. In one embodiment, context structures 202 stores the workflow-specific global variables 204 for associated workflows 206. FIG. 2 illustrates two workflows 206 A, B; the present invention is not, however, limited to any number of workflows. The context structure 202 may be accessed by a global pointer 208, thereby reducing or eliminating the problem of having multiple workflow-specific global variables. Instead, a single global variable, the global context pointer, is used. After invoking an asynchronous call, the sequential program transformation may store the global context pointer in a local variable 212 of the current function 214 before returning the execution control to the waiting state. Using the promises serialization, this local variable 212 may be available in the workflow continuation for restoring the value of the global context pointer 208, thereby allowing a different global context pointer 208 for each of the executing workflows 206.

In another embodiment of the present invention, the workflow computation is cancelled if all its associated promises are cancelled. The sequence program transformation may be used to store the promise 216 associated with the last asynchronous call in a specific field of the workflow context structure before returning the execution control to the waiting state. When the promise response is available and the workflow may thus continue its execution, this promise is removed from the workflow context. Thus, the cancellation of a workflow computation may be accomplished by cancelling all the promises 216 that are stored in its context.

The parallel program transformation may collect all the promises that are generated by a function by, for example, accessing the promises stored in the context. The execution control may not return to the waiting state after calling an asynchronous function; instead, the associated promise is remembered, and functions marked as parallel return a promise that is be triggered when each of the generated promises generated have their responses available. Although the asynchronous calls are done in sequence, their external computation may be done in parallel.

An exemplary implementation of an embodiment of the present invention appears below. The implementation uses the PYTHON language and its TWISTED library; one of skill in the art will understand, however, that the present invention is not limited to any particular language, library, or extension. The implementation uses an “inlineCallbacks” decorator, which serializes the promises (i.e., “deferreds”) returned by a generator function. The sequence program transformation is implemented by the sequence decorator, which is built on top of the inlineCallbacks decorator by wrapping the generator of deferreds.

| | |
|---|---|
| 1 | def sequence(generator_f): |
| 2 | def wrapper(*args, **kwargs): |

| | |
|---|---|
| 3 | generator = generator_f(*args, **kwargs) |
| 4 | local_context_pointer = global_context_pointer |
| 5 | deferred = generator.send(None) |
| 6 | while True: |

| | |
|---|---|
| 7 | global_context_pointer.cancellation_list[id(deferred)] = |
| | deferred |
| 8 | try: |

| | |
|---|---|
| 9 | result = yield deferred |

| | |
|---|---|
| 10 | except: |

| | |
|---|---|
| 11 | global_context_pointer = local_context_pointer |
| 12 | del |
| | global_context_pointer.cancellation_list[id(deferred)] |
| 13 | type, value, trace_back = sys.exc_info( ) |
| 14 | deferred = generator.throw(type, value, trace_back) |

| | |
|---|---|
| 15 | else: |

| | |
|---|---|
| 16 | global_context_pointer = local_context_pointer |
| 17 | del |
| | global_context_pointer.cancellation_list[id(deferred)] |
| 18 | deferred = generator.send(result) |

| | |
|---|---|
| 19 | return defer.inlineCallbacks(wrapper) |

The above computer code illustrates an implementation of the sequence decorator. Line 3 initializes the generator function, and line 4 stores the value of the global_context_pointer in a local variable. Line 5 initializes the deferred variable. Line 7 stores this deferred for cancellation purposes, and line 9 returns the execution control to the waiting state. When the workflow is resumed, line 16 restores the global_context_pointer of the workflow, line 17 removes the previous deferred from the cancellation list, and line 18 computes the next deferred. If an exception is caught in the execution of an asynchronous call, lines 11 and 12 are equivalent to lines 16 and 17, and line 14 propagates the exception to the generator function.

The parallel program transformation, as shown in the below computer code, is implemented by a parallel decorator, which computes all the deferreds created by the generator function and returns a deferred that is fired when every deferred created by the generator has its response available. In this embodiment, the global_context_pointer is restored before generating every deferred. The implementation of the parallel decorator uses a function DeferredList, which fires the returned deferred when all the deferreds in the deferred_list have their response available:

| | |
|---|---|
| 1 | def parallel(generator_f): |

| | |
|---|---|
| 2 | def wrapper(*args, **kwargs): |

| | |
|---|---|
| 3 | local_context_pointer = global_context_pointer |
| 4 | deferred_list = [ ] |
| 5 | for deferred in generator_f(*args, **kwargs): |

| | |
|---|---|
| 6 | deferred_list.append(deferred) |
| 7 | global_context_pointer =l ocal_context_pointer |

| | |
|---|---|
| 8 | return defer.DeferredList(deferred_list, |
| | consumeErrors=True) |

| | |
|---|---|
| 9 | return wrapper |

Finally, below is presented an example of the programing model to further illustrate some of its benefits. The workflow of the above parallel and/or serial program transmformations may be implemented as:

| | |
|---|---|
| 1 | @parallel |
| 2 | def do_map(databases): |

| | |
|---|---|
| 3 | for database in databases: |

| | |
|---|---|
| 4 | yield database.map( ) |

| | |
|---|---|
| 5 | |
| 6 | @sequence |
| 7 | def do_request( ): |

| | |
|---|---|
| 8 | databases = yield get_databases( ) |
| 9 | queries = yield do_map(databases) |
| 10 | result = reduce(queries) |
| 11 | defer.returnValue(result) |

In the above example, the function do_request( ) is decorated as sequence to ensure that the execution returns to the waiting state until the response for an asynchronous call is ready. Therefore, the variable databases are initialized with the set of available database instances. The function do_map( ) is decorated as parallel to invoke in parallel all the asynchronous map operations. Once all the map operations have finished, the workflow is resumed to compute the reduce operation and the function defer.returnValue( ) (which is a function that similar to a return( ) function for functions decorated with the sequence and inlineCallbacks decorators) returns the final result.

FIG. 2 illustrates an embodiment of a server 300 that includes the system and method of executing asynchronous functions described above with reference to FIG. 2. In this embodiment, the server 300 includes a processor 302, such as an INTEL XEON, non-volatile storage 304, such as a magnetic, solid-state, or flash disk, a network interface 306, such as ETHERNET or WI-FI, and a volatile memory 308, such as SDRAM. The storage 304 may store computer instructions which may be read into memory 308 and executed by the processor 302. The network interface 306 may be used to communicate with hosts in a cluster and/or a client, as described above. The present invention is not, however, limited to only the architecture of the server 300, and one of skill in the art will understand that embodiments of the present invention may be used with other configurations of servers or other computing devices.

The memory 308 may include instructions 310 for low-level operation of the server 300, such as operating-system instructions, device-driver-interface instructions, or any other type of such instructions. Any such operating system (such as WINDOWS, LINUX, or OSX) and/or other instructions are within the scope of the present invention, which is not limited to any particular type of operating system. The memory 308 further includes instructions for a waiting state 312, wherein a main execution thread of a workflow 314 may wait. A context 316 may be associated with the workflow 314; as described above, the context 316 may store workflow-specific global variables and/or promises associated with one or more asynchronous functions 316. The workflow 214 may include a global-context pointer that points to the global variables in the context 316; local variables in the asynchronous function 318 may store copies of the global-context pointer. A decorator 320 may be used to generate promises associated with the asynchronous functions 318; in one embodiment, the function 318 is marked as sequential or parallel, as described above. Again, the present invention is not limited to only this allocation of instructions or data, and any such arrangement is within its scope.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for executing asynchronous functions in a programming workflow, the method comprising:
storing, in a computer memory, a context structure comprising workflow-specific global variables;
storing, in the computer memory, a global-context pointer variable comprising a pointer to the context structure;
storing the global-context pointer variable in a local variable of an asynchronous function;
executing with a computer processor, from a waiting state of the programming workflow, the asynchronous function; and
restoring the global-context pointer variable with the local variable.

2. The method of claim 1, further comprising storing a promise for the asynchronous function in the context structure.

3. The method of claim 2, wherein the context structure stores promises for a plurality of asynchronous functions.

4. The method of claim 2, further comprising cancelling the programming workflow by cancelling all of the promises in the context structure.

5. The method of claim 1, further comprising generating a promise for the asynchronous function, wherein the asynchronous function has been marked as sequential.

6. The method of claim 1, wherein the asynchronous function has been marked as parallel.

7. The method of claim 6, further comprising returning a promise that is to be triggered when the asynchronous function and at least one other asynchronous function marked as parallel have completed execution.

8. A system for executing asynchronous functions in a programming workflow, the system comprising:
a computer processor configured for executing computer instructions for computationally executing the steps of:
i. storing a context structure comprising workflow-specific global variables;
ii. storing a global-context pointer variable comprising a pointer to the context structure;
iii. storing the global-context pointer variable in a local variable of an asynchronous function;
iv. executing with a computer processor, from a waiting state of the programming workflow, the asynchronous function; and
v. restoring the global-context pointer variable with the local variable; and
a computer memory for storing the context structure and global-context pointer variable.

9. The system of claim 8, wherein the computer process is further configured for storing a promise for the asynchronous function in the context structure.

10. The system of claim 9, wherein the context structure stores promises for a plurality of asynchronous functions.

11. The system of claim 9, wherein the computer process is further configured for cancelling the programming workflow by cancelling all of the promises in the context structure.

12. The system of claim 8, wherein the computer process is further configured for generating a promise for the asynchronous function, wherein the asynchronous function has been marked as sequential.

13. The system of claim 8, wherein the asynchronous function has been marked as parallel.

14. The system of claim 13, wherein the computer process is further configured for returning a promise that is to be triggered when the asynchronous function and at least one other asynchronous function marked as parallel have completed execution.
